(19) United States
(12) Patent Application Publication
(10) Pub. No.: US 2007/0058530 A1
(43) Pub. Date: Mar. 15, 2007

(54) Apparatus, computer readable medium and method for redundant data stream control

(75) Inventors: Thomas H. Adams, San Antonio, TX (US); Michael Raftelis, San Antonio, TX (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 11/226,111

(22) Filed: Sep. 14, 2005

(51) Int. Cl. H04J 3/14

(52) U.S. Cl. 370/225

(57) ABSTRACT

An apparatus, computer readable medium, and method for redundant data stream control. The computer readable medium may include a first evaluation code segment for determining a first status of a first redundant data stream based at least in part on a first parameter and a predetermined policy, a second evaluation code segment for determining a second status of a second redundant data stream based on a second parameter and the predetermined policy, and an output code segment for transmitting a signal based at least in part on at least one of the first status and the second status. The first parameter is based at least in part on the first redundant data stream and the second parameter is based at least in part on the second redundant data stream. The first status is valid or invalid and the second status is valid or invalid.

### BACKGROUND OF THE DISCLOSURE

1. Field of the Disclosure

This disclosure relates generally to an apparatus, computer readable medium, and method for redundant data stream control.

2. Background Art

Conventional networking environments may require high availability. The high availability requirement may be exemplified by modern network design specifications which may, in turn, require a network to achieve “five nines” (i.e., 99.999%) availability.

Providing redundancy of critical networking components and/or data streams may be one general approach to achieving such high availability. Conventional network components (e.g., routers) may incorporate a limited set of redundancy functions. However, such conventional network components generally operate as relatively discrete elements of a network (i.e. independently of other devices on the network). Accordingly, conventional network components may detect a limited set of hard failures (e.g., cable cut, power supply failure, etc.) but may be unable to detect soft failures (e.g., signal degradation, line noise, etc.). The limited ability to detect hard failures and the generally inability to detect soft failures may result from an inability of the conventional component to perform the type of network analysis generally required for detection of many hard and/or soft failures. Similarly, the discrete nature of conventional network components may limit the ability of such a component to respond to a detected failure. Last, conventional error (i.e., failure) detection is generally fixed such that the detection may not be customized for a particular network implementation.

### BRIEF DESCRIPTION OF THE DRAWINGS

The present disclosure, both as to its organization and manner of operation, together with further objects and advantages thereof, may be best understood with reference to the following description, taken in connection with the accompanied drawings in which:

FIG. 1 is block diagram of an apparatus for controlling a plurality of redundant data streams according to an embodiment of the present disclosure;

FIG. 2 is a block diagram of an embodiment of a controller that may be implemented in connection with the present disclosure;

FIG. 3 is a block diagram of an apparatus for controlling a plurality of redundant data streams according another embodiment of the present disclosure;

FIG. 4 is a block diagram of an apparatus for controlling a plurality of redundant data streams and/or a plurality of redundant data stream sets according to an embodiment of the present disclosure;

FIG. 5 is a block diagram representing data flow from a source device to a target device in accordance with the Open System Interconnection (i.e., OSI) model;

FIG. 6 is a flow diagram of a method for redundant data stream control according to an embodiment of the present disclosure; and

FIG. 7 is a diagrammatic representation of a machine in the form of a computer system.

### DETAILED DESCRIPTION

An apparatus, computer readable medium, and method for redundant data stream control is generally provided by the present disclosure. At least one embodiment of the present disclosure may provide an increase in network hard and/or soft failure detection. In addition, at least one embodiment of the present disclosure may provide an increase in coordination of error detection and/or handling devices. Furthermore, at least one embodiment of the present disclosure may provide user definable and/or configurable error detection such that error detection may be customized for a particular network implementation.

According to one embodiment of the present disclosure, then, an apparatus is provided for redundant data stream control. The apparatus comprises a plurality of data monitors, a switch, and a controller electronically coupled to the data monitors and the switch. Each of the data monitors are configured to electronically couple to a corresponding redundant data stream and are further configured to generate a parameter based at least in part on the corresponding redundant data stream. The switch has a plurality of inputs for electronically coupling the switch to two or more of the corresponding redundant data streams, and an output. The controller is configured to receive the parameter from each of the data monitors, classify each of the corresponding redundant data streams as valid or invalid based on the parameter and a predetermined policy, and determine a state for the switch such that a valid redundant data stream is electronically coupled to the output of the switch.

Also according to an embodiment of the present disclosure, a computer-readable medium storing a program executable by a processor is provided for providing redundant data stream control. The medium comprises a first input code segment for receiving a first redundant data stream, a second input code segment for receiving a second redundant data stream, a first monitor code segment for generating a first parameter based at least in part on the first redundant data stream, a second monitor code segment for generating a second parameter based at least in part on the second redundant data stream, a first evaluation code segment for determining a status of the first redundant data stream based on the first parameter and a predetermined policy, a second evaluation code segment for determining a status of the second redundant data stream based on the second parameter and the predetermined policy, and an output code segment for transmitting the first or second redundant data stream based at least in part on at least one of the status of the first redundant data stream and the status of the second redundant data stream. The status of the first redundant data stream is valid or invalid. Similarly, the status of the second redundant data stream is valid or invalid.

Further according to an embodiment of the present disclosure, another computer-readable medium storing a program executable by a processor is provided for providing redundant data stream control. The medium comprises a first evaluation code segment for determining a first status of a first redundant data stream based at least in part on a first parameter and a predetermined policy, a second evaluation code segment for determining a second status of a second redundant data stream based on a second parameter and the predetermined policy, and an output code segment for transmitting a signal based at least in part on the first status and/or the second status. The first and second parameters are based at least in part on the first and second redundant data streams, respectively. The first status is valid or invalid. Similarly, the second status is valid or invalid

Still further according to an embodiment of the present disclosure, a method is provided for providing redundant data stream control. The method comprises the steps of generating a first parameter based at least in part on a first redundant data stream, generating a second parameter based at least in part on a second redundant data stream, determining a status of the first redundant data stream based on the first parameter and a predetermined policy, determining a status of the second redundant data stream based on the second parameter and the predetermined policy, and transmitting the first or second redundant data stream based at least in part on the status of the first redundant data stream and/or the status of the second redundant data stream. The status of the first redundant data stream is valid or invalid. Similarly, the status of the second redundant data stream is valid or invalid.

In the description below, these terms may be defined as follows:

Source: A supplier of a service such as a call server, a web server, a video acquisition device, and the like.

Data Stream (i.e., stream, data feed, feed): A sequence of data packets (i.e., content, information, etc.) from a source.

Redundant Data Stream (i.e., redundant stream, redundant data feed, redundant feed): One of a plurality of identical, generally equivalent, or substantially similar data streams. In normal operation, any redundant data stream may be substituted for any other redundant data stream.

Hard Failure: An occurrence wherein a device may be rendered inoperable or substantially incapable of performing an operation for which the device was designed. Examples of a hard failure may include cabling breaks, power supply failures and the like.

Soft Failure: An occurrence wherein a device may perform an operation for which the device was designed but the performance of the operation is degraded.

Open System Interconnection model (i.e., OSI Model): A standard, adopted by the International Organization of Standards (i.e., the ISO), for providing a framework for implementing networking protocols. The framework generally comprise seven hierarchical layers. Each layer may represent a step in transmitting a data stream to a target device and/or receiving a data stream from a source device. The layers are generally referred to as the Application Layer (i.e., Layer 7), the Presentation Layer (i.e., Layer 6), the Session Layer (i.e., Layer 5), the Transport Layer (i.e., Layer 4), the Network Layer (i.e., Layer 3), the Data Link Layer (i.e., Layer 2), and the Physical Layer (i.e., Layer 1).

It is to be understood that the previous and subsequently disclosed embodiments are merely exemplary. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art to variously employ the present disclosure. In the figures and in the discussion that follows, like reference numbers indicate like elements.

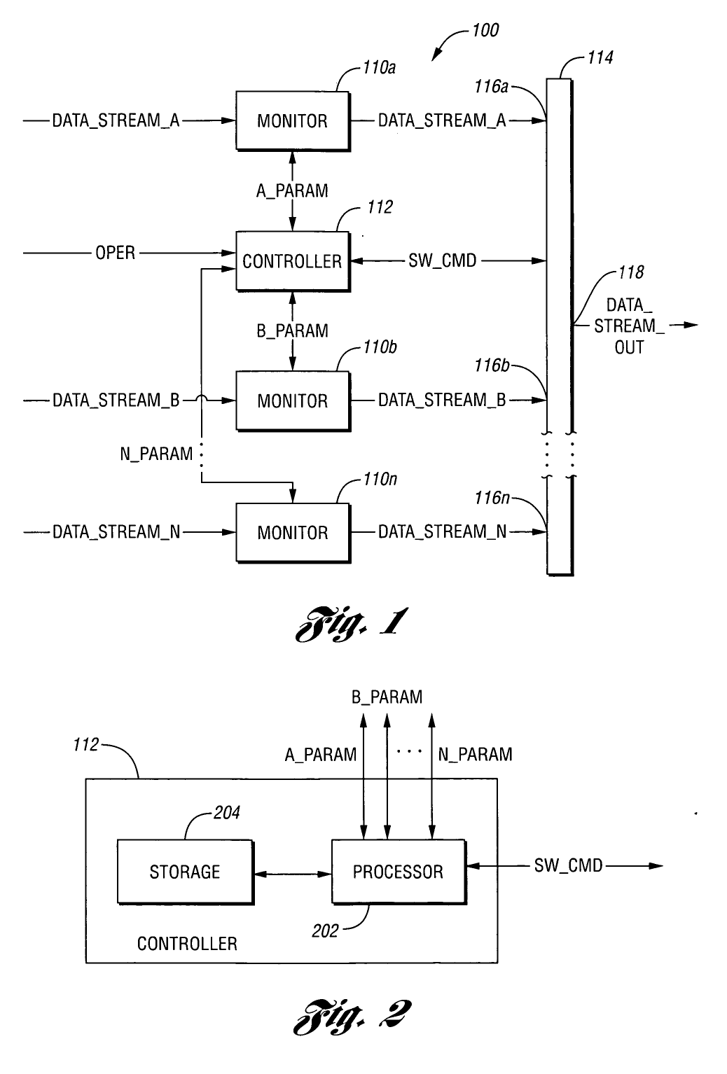

Referring to FIG. 1, an apparatus 100 for controlling a plurality of redundant data streams (e.g., DATA_STREAM_A-DATA_STREAM_N) according to at least one embodiment of the present disclosure is shown. The apparatus 100 may comprise a plurality of data monitors 110 (e.g., 110a-110n), a controller 112, and a switch 114.

Each data monitor 110 may be electronically coupled to a corresponding redundant data stream and may be any suitable device, such as a computer, a processor, or other logical device, for generating a parameter based at least in part on the corresponding redundant data stream. For example, in at least one embodiment, the data monitor 110a may be electronically coupled to the corresponding redundant data stream DATA_STREAM_A and may generate a parameter A_PARAM based at least in part on DATA_STREAM_A. Similarly, in at least one embodiment, the data monitor 110b may be electronically coupled to the corresponding redundant data stream DATA_STREAM_B and may generate a parameter B_PARAM based at least in part on DATA_STREAM_B. Likewise, in at least one embodiment, the data monitor 110n may be electronically coupled to the corresponding redundant data stream DATA_STREAM_N and may generate a parameter N_PARAM based at least in part on DATA_STREAM_N. However, a data monitor 110 may be electronically coupled to any appropriate redundant data stream for generating a parameter based at least in part on the redundant data stream such that the design criteria of a particular application is met.

In at least one embodiment of the present disclosure, one or more data monitors 110 may be user (i.e., operator) programable (i.e., definable, configurable, etc.) such that the monitor 110 may generate a parameter based at least in part on the corresponding redundant data stream and a user configuration.

In general, the controller 112 may be a computer or other logical device, such as an application specific integrated circuit, which executes application programs and/or which performs other logical exercises. It is contemplated that all or part of the functionality of the components in the controller 112 may be incorporated into a single controller, as shown in FIG. 1. Alternatively, the components in the controller 112 may be distributed among a plurality of controllers (not shown) and/or other components of the apparatus 100.

The controller 112 may be electronically coupled to each of the data monitors 110. In general, the controller 112 may receive the parameter (e.g., A_PARAM, B_PARAM, N_PARAM, etc.) from each of the data monitors 110, classify each of the corresponding redundant data streams (e.g. DATA_STREAM_A -DATA_STREAM_N, etc.) as valid or invalid based on the parameter and a predetermined policy, and generate a signal SW_CMD. The controller 112 may be programable by an operator such that one or more predetermined policy may be user definable and/or configurable. The signal SW_CMD may be presented to the switch 114 and may determine a state (i.e., position, electronic connection) for the switch 114.

In at least one embodiment of the present disclosure, the controller may be configured to receive an operator (i.e., user) initiated input (i.e., signal) OPER and to generate the signal SW_CMD is response to the operator initiated input. Accordingly, a state for the switch 114 may be based on the operator initiated input.

The switch 114 may comprise a plurality of inputs 116 (e.g., 116a-116n) and an output 118. Each of the inputs 116 may be configured for electronically coupling the switch 114 to a corresponding redundant data stream (i.e., a redundant data stream corresponding to a data monitor 110). The switch 114 may be electronically coupled to the controller 112 such that the switch 114 may receive the signal SW_CMD. The switch 114 may electronically couple a valid redundant data stream to the output 118 in response to the signal SW_CMD. Accordingly, a valid redundant data stream may be transmitted to a target device (not shown) via the output 118 in response to the signal SW_CMD.

While the present disclosure has been described with reference to a plurality of data monitors 110, it should be understood that the plurality of data monitors 110 may be defined to include a plurality of logical data monitors. That is, one or more logical data monitors may be defined within a single device (e.g., computer, logical device, etc.) such that the single device may electronically couple to a plurality of redundant data streams and may generating a parameter for each redundant data stream based at least in part on the redundant data stream.

Furthermore, while the present disclosure has been described within the context of the apparatus 100, it is contemplated that all or part of the functionality of the apparatus 100 may be performed by (i.e., distributed among) one or more components of a system such that the apparatus 100 may comprises one or more system components.

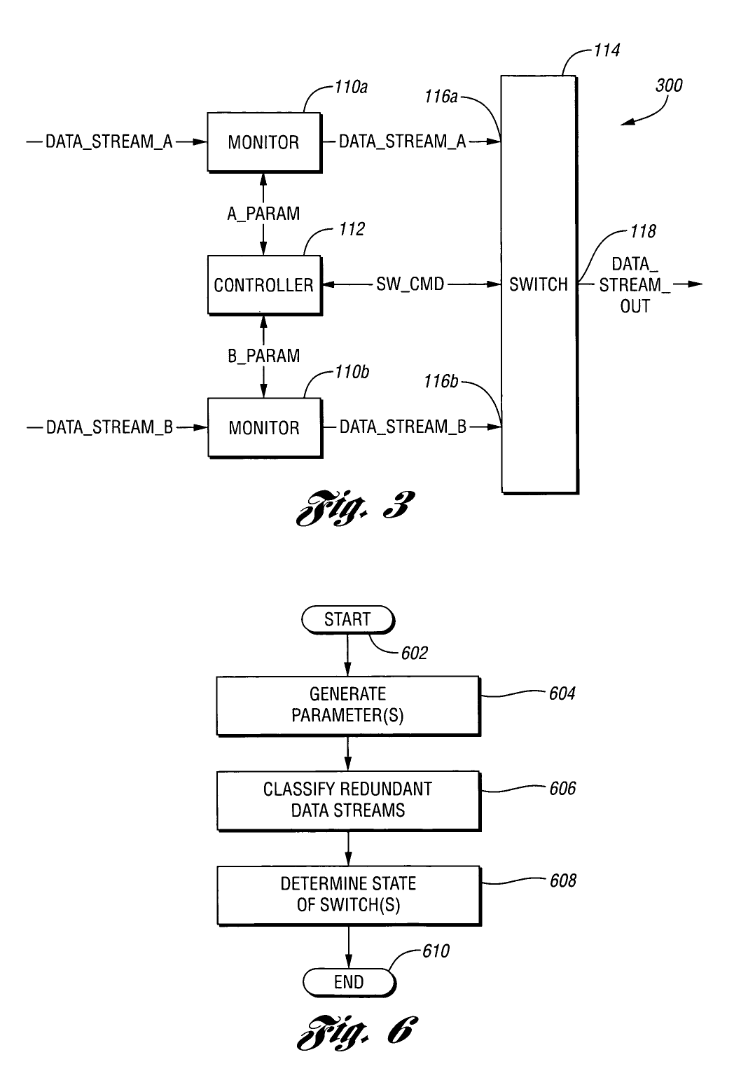

Referring to FIG. 2, a block diagram illustrating an embodiment of the controller 112 that may be implemented in connection with the present disclosure is shown. The controller 112 may include a processor 202 or other logical device for performing logical exercises and a storage device 204.

The processor 202 may be electronically coupled to each of the data monitors 110. In general, the processor 202 may receive the parameter (e.g., A_PARAM, B_PARAM, N_PARAM, etc.) from each of the data monitors 110, classify each of the corresponding redundant data streams (e.g. DATA_STREAM_A -DATA_STREAM_N) as valid or invalid based on the parameter and a predetermined policy, and generate the signal SW_CMD.

The storage device 204 may be any appropriate data storage device for recording the parameters, such as a random access memory RAM, a memory chip, an EPROM, an EEPROM, a PROM, a hard drive, a floppy drive, and the like. The storage device 204 may be electronically coupled to the processor 202 for receiving, storing and/or transmitting one or more of the parameters (e.g., A_PARAM-N_PARAM).

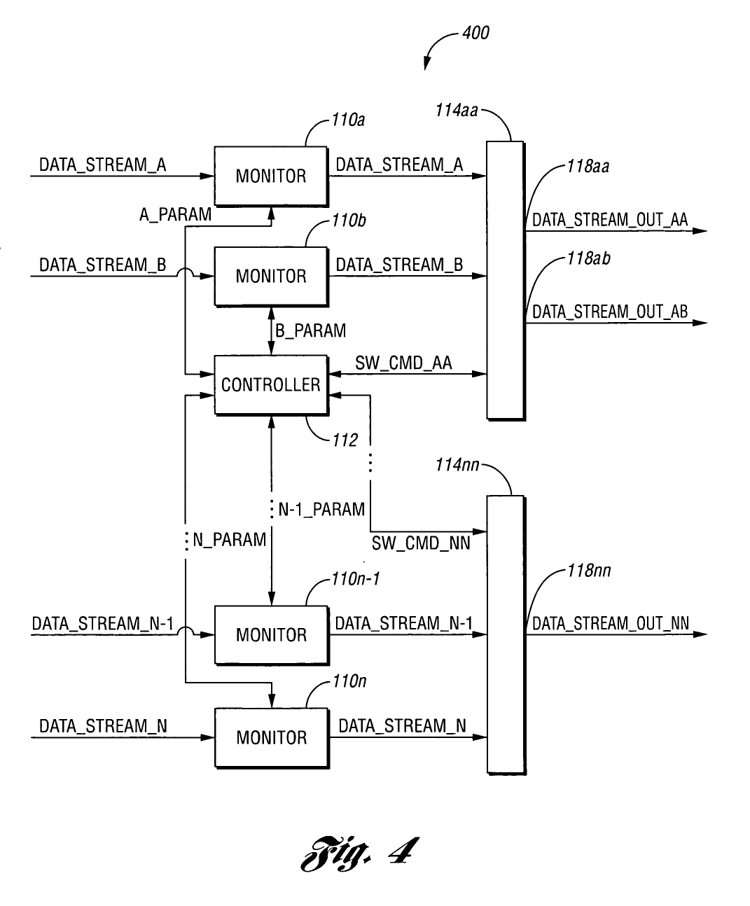

Referring to FIG. 3, an apparatus 300 for controlling a plurality of redundant data streams according to at least one embodiment of the present disclosure is shown. The apparatus 300 may be implemented similarly to the apparatus 100 with the exception that the apparatus 300 is generally configured for controlling a total of two redundant data streams (i.e., DATA_STREAM_A, DATA_STREAM_B).

Referring to FIG. 4, an apparatus 400 for controlling a plurality of redundant data streams and/or a plurality of redundant data stream sets according to at least one embodiment of the present disclosure is shown. The apparatus 400 may be implemented similarly to the apparatus 100 with the exception that the controller 112 of the apparatus 400 may generate a plurality of signals (e.g., SW_CMD_AA-SW_CMD_NN) and the apparatus 400 may comprise a plurality of switches 114 (e.g., 114aa-114nn), each having one or more outputs 118.

In at least one embodiment of the present disclosure, DATA_STREAM_A and DATA_STREAM_B may form a first redundant data stream set and DATA_STREAM_N−1 and DATA_STREAM_N may form a second redundant data stream set. That is, the first redundant data stream set may represent a data stream from a first source and the second redundant data stream set may represent data from a second source. Accordingly, in normal operation, DATA_STREAM_A may be substituted for DATA_STREAM_B and DATA_STREAM_N-1 may be substituted for DATA_STREAM_N but neither member of the first data stream may be substituted for either member of the second data stream set and vice-versa. In such an embodiment, the controller 112 may receive parameters from each of the redundant data stream sets and may generate a plurality of signals (e.g., SW_CMD_AA, SW_CMD_NN) such that a valid redundant data stream from the first redundant data stream set may be electronically coupled to one or more output 118 (e.g., 118aa, 118bb, etc.) of a first switch 114aa and a valid redundant data stream from the second redundant data stream set may be electronically coupled to one or more output 118 (e.g., 118nn) of a second switch 114nn. Such an embodiment may reduce one or more implementation cost as a single controller 112 may be implemented to control a plurality of data stream sets.

In at least one other embodiment of the present disclosure, DATA_STREAM_A-DATA_STREAM_N may form a single redundant data stream set. That is, the DATA_STREAM_A-DATA_STREAM_N each may represent a single data stream from a single source. Accordingly, in normal operation, any data stream may be substituted for any other data stream. In such an embodiment, the controller 112 may receive parameters from each of the redundant data streams (i.e., DATA_STREAM_A-DATA_STREAM_N) and may generate a plurality of signals (e.g., SW_CMD_AA, SW_CMD_NN) such that a valid redundant data stream may be electronically coupled to one or more output 118 (e.g., 118aa, 118ab, 118nn etc.) of a plurality of switches 114 (e.g., 114aa-114nn). Such an embodiment may provide switch level redundancy of the valid redundant data stream.

Similarly, in yet at least on other embodiment of the present disclosure, a valid redundant data stream may be electronically coupled to a plurality of outputs 118 (e.g., 118aa, 118ab) of a switch 114 (e.g., 114aa) such that a minimum number of redundant data streams may be maintained when a redundant data stream (e.g., DATA_STREAM_B) fails. For example, in such an embodiment, failure of DATA_STREAM_B may not decrease the number of redundant data streams as the switch 114aa may provide multiple instances of the redundant data stream DATA_STREAM_A via a plurality of outputs 118 (e.g., 118aa, 118ab).

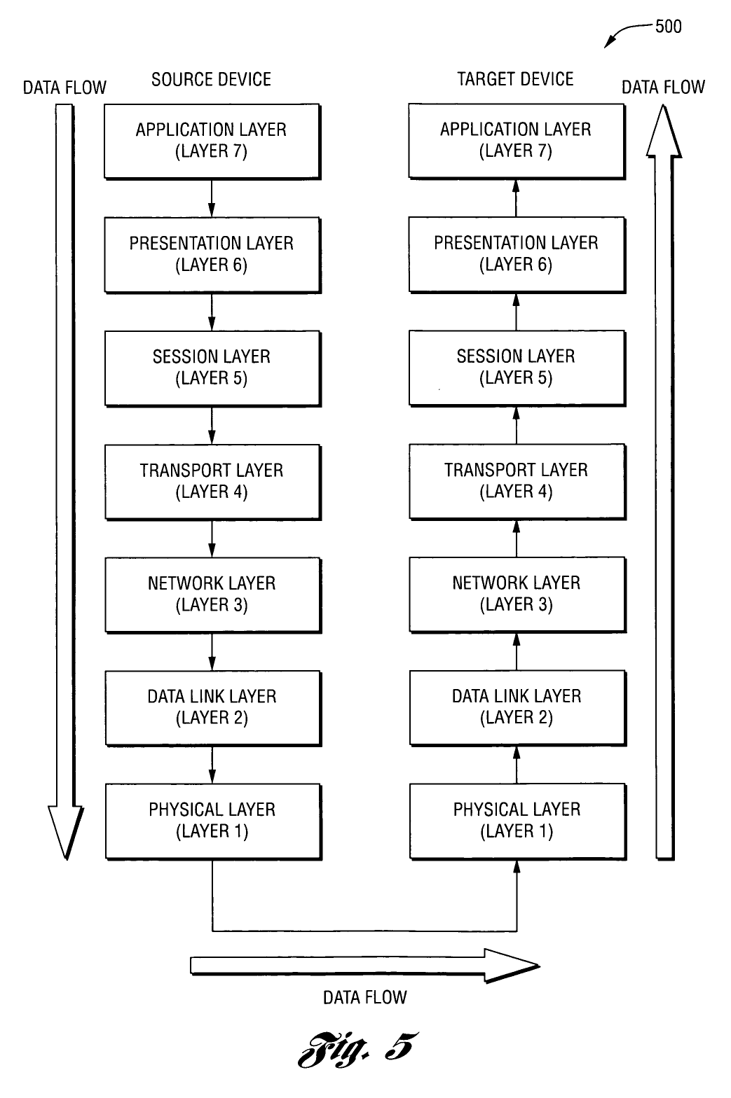

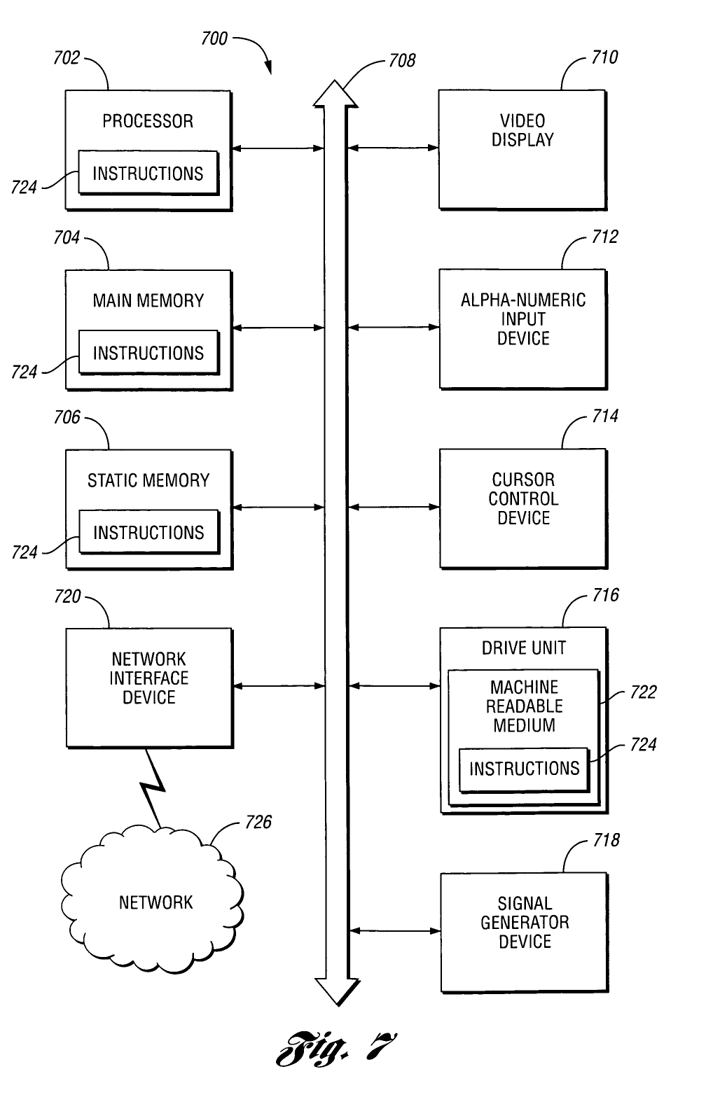

Referring to FIG. 5, a block diagram 500 representing data flow from a source device to a target device in accordance with the Open System Interconnection (i.e., OSI) model is shown. As illustrated in FIG. 5, the OSI model generally comprises an Application layer (i.e. layer 7), a Presentation layer (i.e., layer 6), a Session layer (i.e., layer 5), a Transport layer (i.e., layer 4), a Network layer (i.e., layer 3), a Data Link layer (i.e., layer 2), and/or a Physical layer (i.e., layer 1). As may be elaborated upon in the subsequent discussion of FIG. 6, at least one embodiment of the present disclosure may evaluate one or more layers of the OSI model to determine an occurrence of a hard and/or soft failure.

It is to be understood that the OSI model may be superseded by an equivalent model having essentially the same functions. Accordingly, a subsequent model having essentially the same functions as the OSI model may be considered an equivalent of the OSI model within the spirit and scope of the present disclosure. Similarly, a layer within the subsequent model having essentially the same functions as an OSI model layer may be considered an equivalent of the OSI model layer within the spirit and scope of the present disclosure.

Referring to FIG. 6, a flow diagram of a method 600 for redundant data stream control according to at least one embodiment of the present disclosure is shown. The method 600 may be advantageously implemented in connection with any appropriate system to meet the design criteria of a particular application, such as the systems 100, 300 and 400 described previously in connection with FIGS. 1, 3 and 4, respectively. In particular the method 600 may be performed by a logical device, such as the controller 112 and/or processor 202. The method 600 generally includes a plurality of blocks or steps that may be performed serially. As will be appreciated by one of ordinary skill in the art, the order of the block/steps shown in FIG. 6 is exemplary and the order of one or more block/steps may be modified within the spirit and scope of the present disclosure. In addition, the blocks/steps of the method 600 may be performed in at least one non-serial (or non-sequential) order, and one or more blocks/steps may be omitted to meet the design criteria of a particular application. Similarly, two or more of the blocks/steps of the method 600 may be performed in parallel. Block 602 represents an entry point into the method 600.

At step 604, a plurality of parameters may be generated for a plurality of redundant data streams. Each parameter generally corresponds to a redundant data stream such that the parameter may reflect a characteristic and/or content of the corresponding redundant data stream.

In at least one embodiment of the present disclosure, the parameter may be based at least in part on Open System Interconnection (i.e., OSI) model layer information of the corresponding redundant data stream, such as Application layer information, Presentation layer information, Session layer information, Transport layer information, Network layer information, Data Link Layer information, and/or Physical layer information. Because the OSI model is generally not protocol specific (i.e., the OSI model is generally a framework for implementing a number of networking protocols, the OSI model is generally protocol agnostic), a parameter based on OSI layer information may be protocol agnostic.

At step 606, each corresponding redundant data stream may be classified as valid or invalid (i.e., a status of each corresponding redundant data stream may be determined) based at least in part on the parameter and a predefined policy (i.e., policy).

In at least one embodiment of the present disclosure, the parameter may be based at least in part on Physical layer information and/or Data Link layer information and the policy may define an invalid redundant data stream as a redundant data stream having a physical failure (e.g., a hard failure) of a component of the redundant data stream.

In at least one other embodiment of the present disclosure, the parameter may be based at least in part on Network layer information and the policy may define an invalid redundant data stream as a redundant data stream having an invalid address. Detection of an invalid address may be one example of a soft failure detection. However, an invalid address may be caused by a hard failure.

In at least one other embodiment of the present disclosure, the parameter may be based at least in part on Application layer information and the policy may define an invalid redundant data stream as a redundant data stream having a predetermined quantity of invalid packet arrangements during a predetermined duration (e.g., 5 invalid packet arrangements in 3 minutes).

In at least one other embodiment of the present disclosure, the parameter may be based at least in part on Application layer information and the policy may define an invalid redundant data stream as a redundant data stream wherein a characteristic of a data packet is inconsistent with a known activity of a source (i.e., service) of the redundant data stream. Such an embodiment may detect invalid packet sequencing, packet errors, and/or missing data packets.

In at least one other embodiment of the present disclosure, the parameter may be based at least in part on an active bit rate of the corresponding redundant data stream and the policy may define an invalid redundant data stream as a redundant data stream having an active bit rate that deviates from an active bit rate of one or more other redundant data. In at least one embodiment, a predetermined amount and/or a predetermined period of time may be implemented such that the policy may define an invalid redundant data stream as a redundant data stream having an active bit rate that deviates from an active bit rate of one or more other redundant data streams by the predetermined amount and/or for the predetermined period of time. Such an embodiment may be particularly useful in determining hard and/or soft failures in a video data stream as a video data stream may be characterized by frequent and/or substantial changes in bandwidth during normal operation.

In at least one other embodiment of the present disclosure, the parameter may be based at least in part on an active bit rate of the corresponding redundant data stream. Furthermore, an active bit rate profile may be generated for each of the corresponding redundant data streams from the parameter of each of the corresponding redundant data streams, and the policy may define an invalid redundant data stream as a redundant data stream having an active bit rate profile that deviates from a known valid active bit rate profile and/or an active bit rate profile of one or more other redundant data streams by a predetermined amount. Such an embodiment may be particularly useful in determining hard and/or soft failures in a video data stream as a video data stream may be characterized by frequent and/or substantial changes in bandwidth during normal operation.

In at least one embodiment of the present disclosure, a policy may include at least one upper threshold (i.e., upper limit) and/or lower threshold (i.e., lower limit) such that the policy may define an invalid redundant data stream based at least in part on the upper and/or lower threshold.

At step 608, a state for one or more switches (e.g., 114) may be determined such that a valid redundant data stream may be electronically coupled to an output (e.g., 118) of the switch. At least one embodiment of the present disclosure may also provide for a redundant (i.e., valid or invalid) data stream to be electronically coupled to an output of the switch based on a signal from an operator (i.e., an operator initiated input), such as the signal OPER.

Block 610 represents an exit point out of the method 600.

FIG. 7 is a diagrammatic representation of a machine in the form of a computer system 700 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated in herein above. The instructions 724 may also reside, completely or at least partially, within the main memory 704, the static memory 706, and/or within the processor 702 during execution thereof by the computer system 700. The main memory 704 and the processor 702 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Accordingly, an apparatus, computer readable medium, and method for redundant data stream control is generally provided by the present disclosure. At least one embodiment of the present disclosure may provide an increase in network hard and/or soft failure detection. In addition, at least one embodiment of the present disclosure may provide an increase in coordination of error detection and/or handling devices. Furthermore, at least one embodiment of the present disclosure may provide user definable and/or configurable error detection such that error detection may be customized for a particular network implementation.

While embodiments have been illustrated and described, it is not intended that these embodiments illustrate and describe all possible forms of the disclosure. Rather, the words used in the specification are words of description rather than limitation, and it is understood that various changes may be made without departing from the spirit and scope of the disclosure.

What is claimed is:

1. An apparatus for redundant data stream control, the apparatus comprising:
a plurality of data monitors, each of the data monitors configured to electronically couple to a corresponding redundant data stream and further configured to generate a parameter based at least in part on the corresponding redundant data stream;
a switch having a plurality of inputs for electronically coupling the switch to two or more of the corresponding redundant data streams, and an output; and
a controller electronically coupled to the data monitors and the switch,
wherein the controller is configured to receive the parameter from each of the data monitors, classify each of the corresponding redundant data streams as valid or invalid based on the parameter and a predetermined policy, and determine a state for the switch such that a valid redundant data stream is electronically coupled to the output of the switch.

2. The apparatus of claim 1 wherein the parameter is based at least in part on Open System Interconnection model layer information of the corresponding redundant data stream.

3. The apparatus of claim 2 wherein the parameter is based at least in part on one of Physical layer information and Data Link layer information of the Open System Interconnection model and the predetermined policy defines an invalid redundant data stream as a redundant data stream having a physical failure of a component of the redundant data stream.

4. The apparatus of claim 2 wherein the parameter is based at least in part on Network layer information of the Open System Interconnection model and the predetermined policy defines an invalid redundant data stream as a redundant data stream having an invalid address.

5. The apparatus of claim 2 wherein the parameter is based at least in part on Application layer information of the Open System Interconnection model, and the predetermined policy defines an invalid redundant data stream as a redundant data stream having a predetermined quantity of invalid data packet arrangements during a predetermined duration.

6. The apparatus of claim 2 wherein the parameter is based at least in part on Application layer information of the Open System Interconnection model, and the predetermined policy defines an invalid redundant data stream as a redundant data stream wherein a characteristic of a data packet is inconsistent with a known activity of a source of the redundant data stream.

7. The apparatus of claim 1 wherein the parameter is based at least in part on an active bit rate of the corresponding redundant data stream, and the predetermined policy defines an invalid redundant data stream as a redundant data stream having an active bit rate that deviates from an active bit rate of one or more other redundant data streams by a predetermined amount for a predetermined period of time.

8. The apparatus of claim 1 wherein the parameter is based at least in part on an active bit rate of the corresponding redundant data stream, the controller generates an active bit rate profile for each of the corresponding redundant data streams from the parameter of each of the corresponding redundant data streams, and the predetermined policy defines an invalid redundant data stream as a redundant data stream having an active bit rate profile that deviates by a predetermined amount from at least one of a known valid active bit rate profile and an active bit rate profile of one or more other redundant data streams.

9. The apparatus of claim 1 wherein the predetermined policy includes at least one of an upper threshold and a lower threshold and the predetermined policy defines an invalid redundant data stream based at least in part on at least one of the upper threshold and the lower threshold.

10. The apparatus of claim 1 wherein the controller is further configured to receive an operator initiated input and to determine a state for a corresponding switch such that a redundant data stream is electronically coupled to an output of the corresponding switch based on the operator initiated input.

11. A computer-readable medium storing a program executable by a processor for providing redundant data stream control, the medium comprising:
a first input code segment for receiving a first redundant data stream;
a second input code segment for receiving a second redundant data stream;
a first monitor code segment for generating a first parameter based at least in part on the first redundant data stream;
a second monitor code segment for generating a second parameter based at least in part on the second redundant data stream;
a first evaluation code segment for determining a status of the first redundant data stream based on the first parameter and a predetermined policy, wherein the status of the first redundant data stream is valid or invalid;
a second evaluation code segment for determining a status of the second redundant data stream based on the second parameter and the predetermined policy, wherein the status of the second redundant data stream is valid or invalid; and
an output code segment for transmitting the first or second redundant data stream based at least in part on at least one of the status of the first redundant data stream and the status of the second redundant data stream.

12. The computer-readable medium of claim 11 wherein the first parameter is based at least in part on Open System Interconnection model layer information of the first redundant data stream and the second parameter is based at least in part on Open System Interconnection model layer information of the second redundant data stream.

13. The computer-readable medium of claim 12 wherein the first and second parameters are each based at least in part on at least one of Physical layer information and Data Link layer information of the Open System Interconnection model, and the predetermined policy defines an invalid redundant data stream as a redundant data stream having a physical failure of a component.

14. The computer-readable medium of claim 12 wherein the first and second parameters are each based at least in part on Network layer information of the Open System Interconnection model, and the predetermined policy defines an invalid redundant data stream as a redundant data stream having an invalid address.

15. The computer-readable medium of claim 12 wherein the first and second parameters are each based at least in part on Application layer information of the Open System Interconnection model, and the predetermined policy defines an invalid redundant data stream as a redundant data stream having a predetermined quantity of invalid packet arrangements for a predetermined duration.

16. The computer-readable medium of claim 12 wherein the first and second parameters are each based at least in part on Application layer information of the Open System Interconnection model, and the predetermined policy defines an invalid redundant data stream as a redundant data stream wherein a characteristic of a data packet is inconsistent with a known activity of a source of the redundant data stream.

17. The computer-readable medium of claim 11 further comprising:
a first profile code segment for generating an active bit rate profile for the first redundant data stream based at least in part on the first parameter, wherein the first parameter is based at least in part on an active bit rate of the first redundant data stream; and
a second profile code segment for generating an active bit rate profile for the second redundant data stream based at least in part on the second parameter, wherein the second parameter is based at least in part on an active bit rate of the second redundant data stream and the predetermined policy defines an invalid redundant data stream as a redundant data stream having an active bit rate profile that deviates by a predetermined amount from a known valid active bit rate profile.

18. A method for providing redundant data stream control, the method comprising:
generating a first parameter based at least in part on a first redundant data stream;
generating a second parameter based at least in part on a second redundant data stream;
determining a status of the first redundant data stream based on the first parameter and a predetermined policy, wherein the status of the first redundant data stream is valid or invalid;
determining a status of the second redundant data stream based on the second parameter and the predetermined policy, wherein the status of the second redundant data stream is valid or invalid; and
transmitting the first or second redundant data stream based at least in part on at least one of the status of the first redundant data stream and the status of the second redundant data stream.

19. The method of claim 18 wherein the first parameter is based at least in part on Open System Interconnection model layer information of the first redundant data stream and the second parameter is based at least in part on Open System Interconnection model layer information of the second redundant data stream.

20. The method of claim 18 further comprising:
generating an active bit rate profile for the first redundant data stream based at least in part on the first parameter, wherein the first parameter is based at least in part on an active bit rate of the first redundant data stream; and
generating an active bit rate profile for the second redundant data stream based at least in part on the second parameter, wherein the second parameter is based at least in part on an active bit rate of the second redundant data stream and the predetermined policy defines an invalid redundant data stream as a redundant data stream having an active bit rate profile that deviates by a predetermined amount from a known valid active bit rate profile.

21. A computer-readable medium storing a program executable by a processor for providing redundant data stream control, the medium comprising:
a first evaluation code segment for determining a first status of a first redundant data stream based at least in part on a first parameter and a predetermined policy, wherein the first parameter is based at least in part on the first redundant data stream and the first status is valid or invalid;
a second evaluation code segment for determining a second status of a second redundant data stream based on a second parameter and the predetermined policy, wherein the second parameter is based at least in part on the second redundant data stream and the second status is valid or invalid; and
an output code segment for transmitting a signal based at least in part on at least one of the first status and the second status.
